(19) United States
(12) Patent Application Publication
(10) Pub. No.: US 2004/0111324 A1
(43) Pub. Date: Jun. 10, 2004

(54) Integrated point-of-sale and surveillance system

(76) Inventor: Jeong T. Kim, Hawthorn Wood, IL (US)

Correspondence Address: Eric D. Cohen, Esq., Welsh & Katz, Ltd., 22nd Floor, 120 S. Riverside Plaza, Chicago, IL, 60606, US

(21) Appl. No.: 10/313,423

(22) Filed: Dec. 6, 2002

(51) Int. Cl. G06G 1/14; G06F 17/60

(52) U.S. Cl. 705/22

(57) ABSTRACT

A point-of-sale (POS) system for use in a retail establishment includes a computer system configured to track inventory and associate the inventory with a transaction in accordance with a transaction identifier. The computer system further includes a memory subsystem and a display device. The POS system includes a database operatively coupled to the computer system, a cash drawer operatively coupled to and controlled by the computer system, and an image capture device operatively coupled to the computer system and configured to transmit a selected captured image to the computer system for storage. The computer system is configured to store the captured image in the memory subsystem and operatively link the captured image with the transaction identifier upon receipt of a first predetermined signal. The computer system displays the transaction on the display device information, and upon receipt of a second predetermined signal, displays the captured image corresponding to the transaction on the display device.

### FIELD OF THE INVENTION

The present invention relates generally to a method and apparatus for tracking inventory in a retail establishment and more specifically to a method and apparatus for tracking inventory and reducing employee theft in a retail establishment by providing photographic images linked to particular transactions.

### BACKGROUND

The present invention is particularly concerned with integrated security monitoring and transaction processing in retail systems. A retail system typically includes one or more point-of-sale (POS) terminals coupled to a computer configured to process transactions.

All retailers suffer some loss due to fraud and/or theft. It has become known, however, that a large proportion of such loss is attributable to staff and employees of the retail establishment. In that regard, one particularly unsophisticated mode of fraud includes direct theft of cash from the money drawer by an employee. Although this is detectable at the end of the day when the cash total is balanced, if many different employees have access to the same POS terminal, it may be difficult if not impossible to ascertain the identity of the particular employee responsible for the theft. Another example of fraud is collusion at the point of sale, for example by passing goods through the checkout without charging them.

Such theft may also include order canceling. This is more frequent in service-type retail establishments where a customer drops-off goods to be serviced, such as in shoe repair shops and laundry retailers, such as dry-cleaners. In this form of theft, when the customer's clothes are ready to be picked up, the customer pays the employee for the servicing of the clothes, and the employee then locates the clothing on the conveyer and gives the clothing to the customer. The customer believes that a normal transaction has just occurred. However, the employee doesn't complete the transaction on the POS terminal, and pockets the cash. The employee merely recalls the customer account or transaction on the POS terminal to locate the customer's clothing on the conveyer, gives the clothing to the customer as described above, and then cancels the transaction. In some systems, the POS terminal may continue to show that the customer's clothing still remains in inventory, when in fact they do not. Once the order has been cancelled, it is difficult to determine the reason for such cancellation, as some order cancellations may be legitimate.

For example, in a legitimate order cancellation, the customer may return to the retailer and decide not to have his or her articles or clothing serviced, and thus would remove the articles from the retail establishment without servicing. Alternatively, in a laundry-type establishment, servicing may be performed a second time with no charge if the customer is not satisfied with the results of the cleaning the first time. Further, a customer may attempt to pick up his or her clothing, thus the operator would begin the transaction, only to learn that the customer does not have sufficient funds. In that case, the operator would cancel the transaction and the customer would return at a later time to complete the transaction. These are examples of legitimate order canceling.

One known method for attempting to counteract such theft is to intercept the data sent to the till audit roll printer in the POS terminal, and to route this data to a central security computer. The security computer monitors the audit roll data received looking for security related events, where such events would indicate suspicious activity by the POS terminal operator, such as, for example, refunds. When these events are detected by the security computer, a closed circuit video camera is switched on and the actions of the operator are recorded on videotape for subsequent viewing. However, this does not provide a well-integrated system, and it is difficult to synchronize the video tape with the transaction when viewed at a later time. Additionally, it is time consuming to sequence through the videotape to the portion of interest.

At other times, a dispute may arise between a customer and the operator of the POS terminal that does not necessarily involve theft or fraud. A genuine misunderstanding may exist. Although it is known to record transactions using ongoing surveillance that operates, for example, twenty-four hours per day, seven days per week, it is not feasible, except in very unusual circumstances, to replay the video tape to the customer and operator to resolve the dispute in a timely manner. Again, this would be very time consuming, and it may be several hours or days before the surveillance equipment operator could arrange the review of the video tape. In the meantime, the relationship between the customer and the retail establishment could be damaged.

Known computer systems for use in retail establishments do not have sufficient safeguarding capability to deal with the above-mentioned problems. Such systems typically provide rudimentary reporting, such as profitability statements, number of transactions and the like, but do not specifically track cancelled or voided orders or provide instant integrated documentary evidence regarding such cancelled or voided orders.

### SUMMARY

The disadvantages of present inventory management and theft reduction systems and methods may be substantially overcome by providing a novel integrated point-of-sale (POS) and surveillance system.

More specifically, in one embodiment, a POS system for use in a retail establishment includes a computer system configured to track inventory and associate the inventory with a transaction in accordance with a transaction identifier. The computer system further includes a memory subsystem and a display device. The POS system includes a database operatively coupled to the computer system, a cash drawer operatively coupled to and controlled by the computer system, and an image capture device operatively coupled to the computer system and configured to transmit a selected captured image to the computer system for storage. The computer system is configured to store the captured image in the memory subsystem and operatively link the captured image with the transaction identifier upon receipt of a first predetermined signal. The computer system displays the transaction on the display device, and upon receipt of a second predetermined signal, displays the captured image corresponding to the transaction on the display device.

In another embodiment, a method is disclosed for tracking articles provided by a customer to a retail establishment and returned back to the customer, and for reducing theft by an employee. The retail establishment includes a POS system having a computer system, a memory subsystem, a display device, a database, and a cash drawer. The method includes a) operatively coupling an image capture device to the computer system, b) creating a transaction and assigning thereto a transaction identifier when the customer provides the articles to the retail establishment for servicing, c) storing the transaction in the database, d) capturing an image of at least one of the employee and customer when the customer provides the articles to the retail establishment for servicing, when the articles are returned back to the customer, and/or when the employee cancels a transaction, e) storing the captured image and operatively linking the captured image to the transaction via the transaction identifier, and f) upon receipt of predetermined signal, displaying on the display device a transaction specified by a selected transaction identifier along with the linked captured images to determine the parties present at the time of the transaction.

### BRIEF DESCRIPTION OF THE DRAWINGS

The features of the present invention which are believed to be novel are set forth with particularity in the appended claims. The invention, together with further objects and advantages thereof, may best be understood by reference to the following description in conjunction with the accompanying drawings.

FIG. 1 is a high-level functional block diagram of a specific embodiment of a computer system for managing inventory and reducing theft and fraud in a retail establishment;

FIG. 2 is a pictorial view of a specific embodiment of the computer system and an image capture device illustrating the environment of the retail establishment;

FIG. 3 is a representative image of a screen display of a specific embodiment for checking in articles in the retail establishment;

FIG. 4 is a representative image of a screen display of a specific embodiment for pickup of articles in the retail establishment; and

FIG. 5 is a representative image of a screen display of a specific embodiment for a report showing cancelled or voided transactions.

### DETAILED DESCRIPTION

In this written description, the use of the disjunctive is intended to include the conjunctive. The use of definite or indefinite articles is not intended to indicate cardinality. In particular, a reference to “the” object or thing or “an” object or “a” thing is intended to also describe a plurality of such objects or things.

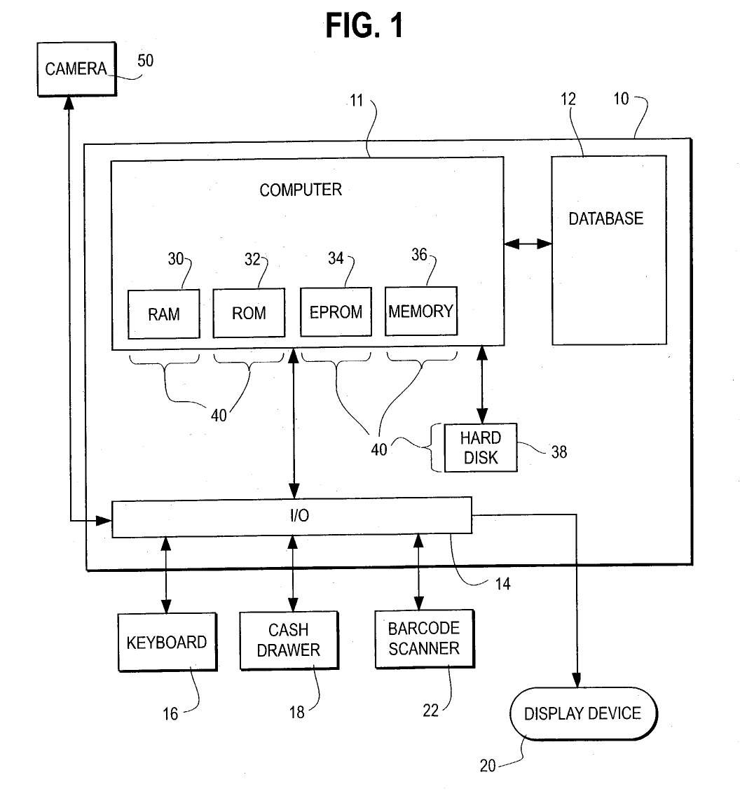

Referring now to FIG. 1, a high level functional block diagram is shown for a point-of-sale (POS) system or terminal 10 for use in a retail establishment. The present invention may be used, for example, in a retail establishment such as in a shoe repair shop, a laundry, a dry cleaners, and the like, and/or in particular, in a retail establishment where a customer delivers goods to the retail establishment for repair or maintenance, and the goods are returned back to the customer, preferably in-person, after servicing or repair at some later time. However, the present invention may be used in any retail establishment, and is not limited to the specific retail establishments mentioned herein. For purposes of illustration only, one specific embodiment described herein relates to a clothes cleaning establishment, such as a laundry or dry-cleaners, but is not intended to be limited in any way to use in this specific type of establishment.

The POS system 10 may include a computer system 11 configured to manage and track the inventory of all articles received by the retail establishment. The computer system 11 may include a database 12 operatively coupled to the computer system, and may be remotely located from the computer system, as is known in the art. Additionally, the POS system 10 may include input/output peripherals 14, such as for example, a keyboard 16 operatively coupled to the computer system 11, a cash drawer 18 (for example, a APG brand cash drawer) operatively coupled to and controlled by the computer system, a display device 20, and a laser optical scanner 22 configured to scan universal product code (UPC) labels (barcode labels) printed on invoice tickets.

The computer system 11 is preferably an IBM compatible personal computer running Microsoft WINDOWS operating system, but the computer may be any suitable device, such as a processor, central processing unit (CPU), microprocessor, RISC (reduced instruction set computer), mainframe computer, mini-computer, work station, single chip computer, distributed processor, server, controller, micro-controller, discrete logic device, remote computer, internet computer, web computer, and the like. The computer system 11 may include various components that are known in the art, such as RAM 30, ROM 32, EPROM 34, other memory 36, hard disk 38, and the like (collectively referred to as memory subsystem or memory 40). The computer system 11 is preferably a commercially available system, and such suitable systems are in widespread use in most retail business establishments.

An image capture device 50 is preferably operatively coupled to the computer system 11. The image capture device 50 is configured to transmit selected captured images to the computer system 11 for storage in the memory subsystem 40, and in particular, in the hard disk 38. The image capture device 50 is preferably a USB-based camera compatible with personal computer systems, as is known in the art. Any suitable imaging device, may be used, such as for example, a web camera, USB camera, video camera, CCD camera, digital camera and the like. Preferably, images captured by image capture device 50 (hereinafter “camera”) are sent to the computer system 11 and stored in the memory subsystem 40 in a suitable format, such as in a “JPG” file. However, any suitable image storage format may be used, as is known in the art.

In one specific embodiment, the POS system 10 is configured to track inventory, such as for example, clothing delivered to the retail establishment by the customer for servicing or repair. The inventory is entered into the database 12, which is preferably a commercially available relational database, such as Microsoft ACCESS XMDB. The software that runs the application may be written in Microsoft Visual Basic, Version 6.0 Dot.Net. However, any suitable database and software development tools may be used.

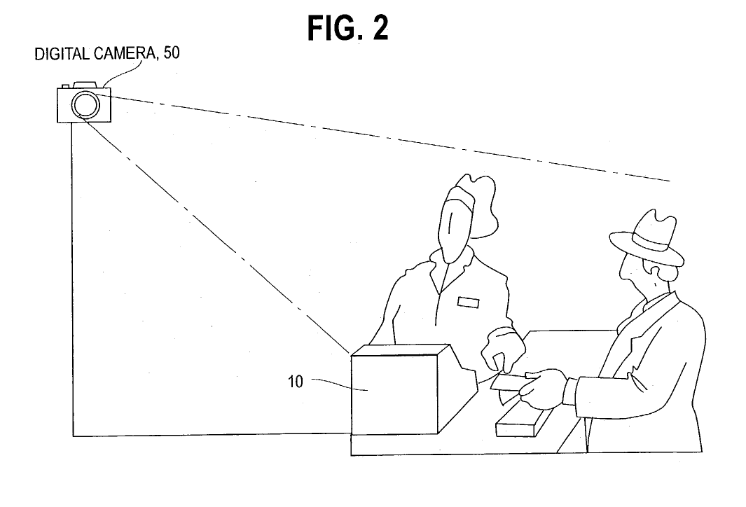

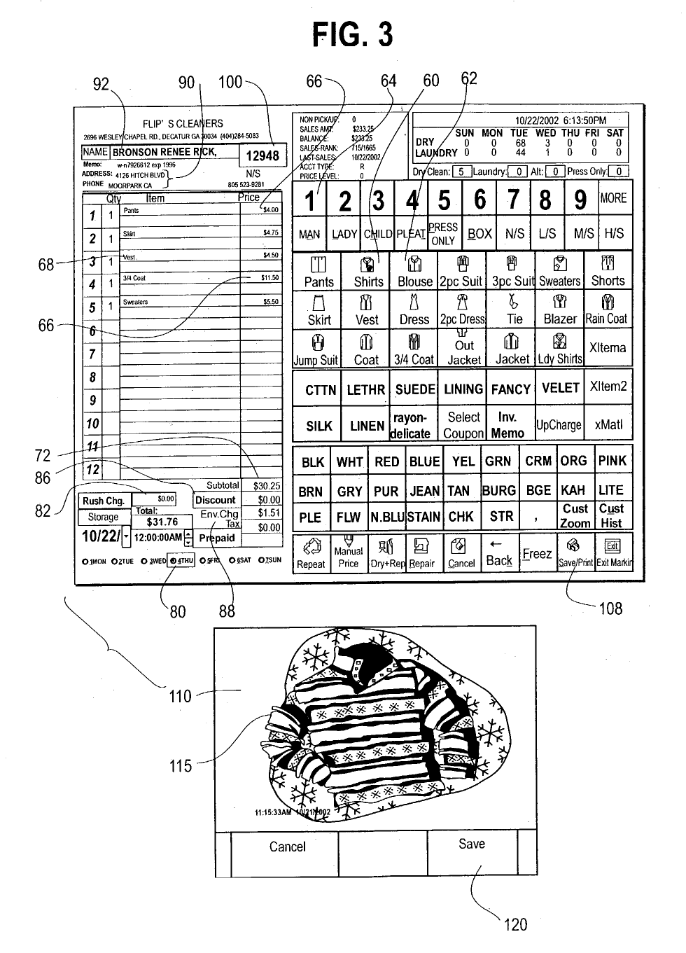

Referring now to FIGS. 1-3, FIG. 2 shows a pictorial representation of the POS system 10 generally, while FIG. 3 shows a specific embodiment of a “screen-shot” that may be displayed to the POS system 10 operator or employee. As shown in the specific illustrated embodiment of FIG. 2, an employee operates the POS system 10, which is coupled to the image capture device or camera 50.

In operation, the screen view of FIG. 3 may be displayed to the operator to begin a transaction. As shown, a customer may desire to drop off various articles of clothing for cleaning or repair. This is referred to as “mark-in.” The operator selects (clicks) the appropriate icon, such as “shirts,” 60 “blouse,” 62 and the like, and enters a number 64 of such articles deposited. A price 66 of each article and its type 68 is automatically tabulated and shown, along with the total 72 associated with the transaction or invoice, the expected pick up date 80, special charges 82, discounts 86, tax 88, and another information customarily associated with the particular retail establishment.

For a “first time” customer, the customer's address 90 and name 92 may be entered during the mark-in process. Additionally, the computer system 11 may assign a conveyer rack location where the articles of clothing are to be hung prior to and/or after servicing.

The information concerning this transaction or “invoice” is stored in the database 12, which may be indexed by any suitable identifier, such as by customer name 92, by an invoice number 100, or both. Any suitable indexing scheme may be used. The paper copy of the invoice may be provided back to the customer and may be printed with a bar code identifier (not shown) that represents the invoice number or transaction identifier 100. The term “invoice identifier,” “invoice number,” “transaction identifier,” and the like may be used interchangeably herein. To print the receipt or invoice for the customer, the operator may finalize the transaction by providing a specific signal to the computer system 11, such as by depressing a particular key on the keyboard or by using the touch-screen capability of the display device, by clicking on the “save/print” icon 108. Of course, any suitable icon or key depression as governed by the software application may cause the transaction to be finalized or “checked-in.”

The invoice is then printed for the customer and the data regarding the transaction is saved in the database 12. However, simultaneously with the aforementioned saving operation, the computer system 11 may receive a photographic image 110 captured from the camera 50 at the time that the operator depresses the “save/print” icon 108. Preferably, the computer system 11 automatically sends a command to the camera 50 causing the camera to capture the image and transmit it to the computer system. Note that the camera 50 is preferable strategically located so as to be able to photograph both the employee and the customer. Of course, the camera 50 may have a suitable wide-angle lens depending upon the location of the camera and distance from the POS system 10. Additionally, the camera 50 may be a wireless digital camera, as is known in the art, which may avoid the need to install cable. Multiple cameras 50 may also be coupled to the POS system 10.

As described above, the digital or captured image 110 saved in the memory subsystem 40 or hard disk 38 may be in JPG format, which is an industry standard, and which is relatively compact and memory efficient. Of course, any suitable format may be used. The digital image 110 is also operatively linked with the transaction identifier, such as with the invoice number 100 so that the transaction and the image 110 may be automatically recalled together without the need to separately find the image associated with the transaction.

The saved image 110 may be useful at a future date for several reasons, as described below. First, the saved image 110 may be useful should a dispute ensue between the customer and the retail establishment. For example, in one embodiment, the customer may deposit a damaged article of clothing for cleaning or repair. To document the damage to the article, the operator may click an “item picture” icon (not shown) to cause the camera 50 to capture an image 115 of the damaged clothing. The damage article of clothing may be strategically positioned by the operator or held up to the camera to more clearly highlight the damage. This image 115, along with the customer/employee image or held up to the camera may be saved in the memory subsystem 40 automatically by the computer system 11 when the employee clicks on the save icon 120. Such documentary evidence in the form of the digital image or photograph 110 may be extremely useful when the customer picks up his or her clothing at a later time. For example, the customer may not remember that the clothing was damaged prior to drop-off. Accordingly, if the customer asserts that the cleaner damaged the clothing, the employee need only recall the transaction via the invoice number 100, and recall the saved photographic image 110 detailing the prior damage. In that way, the customer cannot dispute that the damage was not caused by the retail establishment.

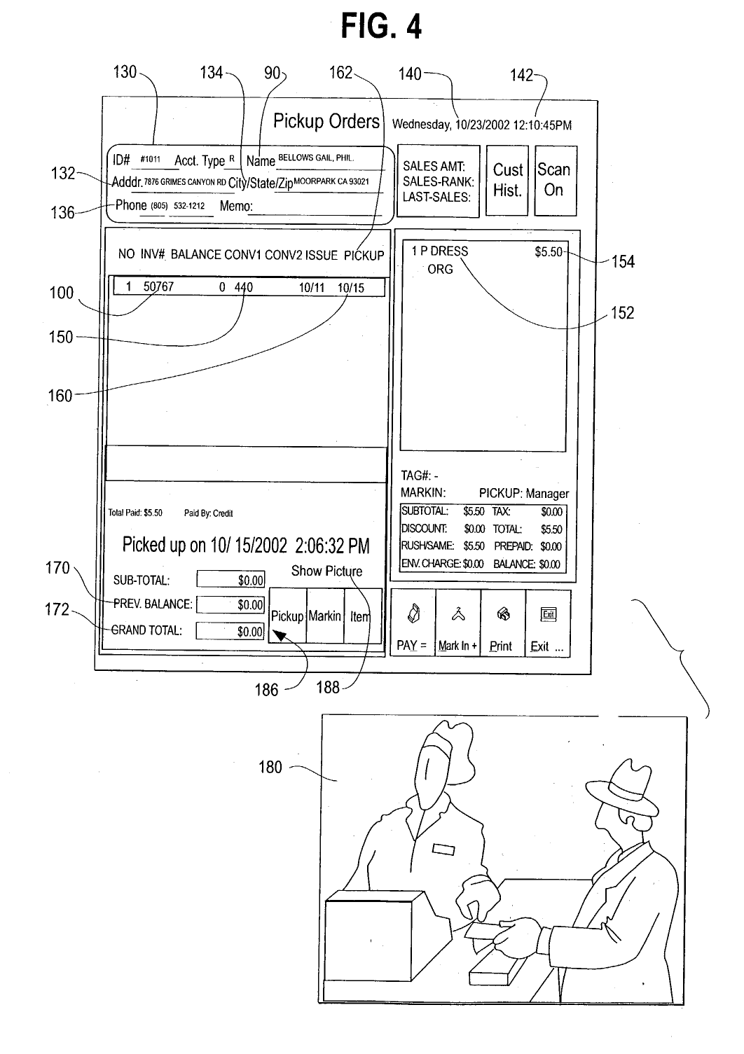

Referring now to FIGS. 1 and 4, FIG. 4 shows a screen view or screen print that may be displayed to the operator during a “pick-up” phase of the retail operation, such as when the customer desires to pick up the articles of clothing from the retail establishment. Of course, the customer may present the invoice or invoice number 100 to the employee, or in lieu of the invoice, the employee may recall the customer transaction based on the customer name 90. Various customer information is displayed, such as, the customer name 90, customer ID number 130, street address 132, city and state 134, telephone number 136, date 140, time 142, conveyer rack location 150, unit of article serviced 152, unit price 154 for servicing the article, expected or actual pick up date 160, whether the customer's clothing has already been picked up and when 162, previous balance 170, grand total 172, and the like.

In one mode, when the customer is about to pick up his or her articles of clothing, the employee may recall the transaction on the display device to ascertain the conveyer rack number 150. This informs the employee where on the conveyer the customer's articles are hanging. The employee then retrieves the articles from the conveyer and provides them to the customer upon payment of the prescribed fees. During this phase of operation, one or more images 180 may be captured and stored. For example, the photographic image 180 may be captured and/or stored when the employee initially recalls the transaction via the transaction number 100. Alternatively, or in addition thereto, another photographic image may be captured and stored when the employee completes the transaction and enters that the customer has paid. In either case, the photographic image 180 is captured when the employee is presented with a screen that permits the employee to ascertain the location of the articles of clothing on the conveyer. This essentially “locks-in” the identity of the employee involved in the transaction.

The photograph image shown as reference number 180 of FIG. 4 represents the environment at the time that the customer pays for the services rendered, and proves that the customer was present for the transaction. Conversely, it may also prove that the customer was not present for the transaction, which may indicate an irregularity, as will be discussed below.

After the pick-up operation has been completed, the same transaction may need to be recalled at a later date. For example, the customer or someone acting on behalf of the customer may return to the retail establishment to pick up the articles of clothing, and may not remember or may not realize that the articles of clothing were previously picked up. In known systems, a dispute may arise because the customer may not be provided with sufficient proof to resolve the situation.

As shown in FIG. 4, an icon labeled “pickup” 186 in the “show picture” 188 dialog box, when activated, will cause the photographic image or images 180 to be recalled, which photographic images were previously saved during the pickup phase of operation. The photographic image 180 is essentially instantly recalled and displayed on the screen upon activation of the appropriate icon or depression of the appropriate key by the employee. Accordingly, the display device 20 may be shown to the customer to prove to the customer that the customer (or some third party) already picked up the articles in question. Accordingly, viewing the photographic image 180 typically resolves the dispute instantly. Although not specifically shown in FIG. 4, the articles of clothing being picked up may also be shown in the photographic image as additional proof for the customer.

Obviously, if the customer is not shown in the photographic image during the pickup phase of operation, some anomaly or unusual circumstances may exist. As described above, one mode theft or fraud involves the employee canceling or voiding the order. Often, a customer may have multiple pending invoices. Using the customer name or one of the invoice numbers, the employee may recall the transaction, along with the other pending invoices corresponding to that customer. In that way, the employee can ascertain the conveyor rack number for each invoice.

The employee may then retrieve all of the customer's clothing for all of the invoices and return the articles of clothing to the customer. The customer would then pay for the three invoices, and presumably would be satisfied that the transactions are complete. However, the employee may finalize only two of the three transactions and cancel the third transaction and pocket the money corresponding to the third transaction. The computer system may continue to indicate that the articles of clothing corresponding to the third invoice were still pending in inventory (i.e., not picked up), but that may not raise any warnings for many months or perhaps longer.

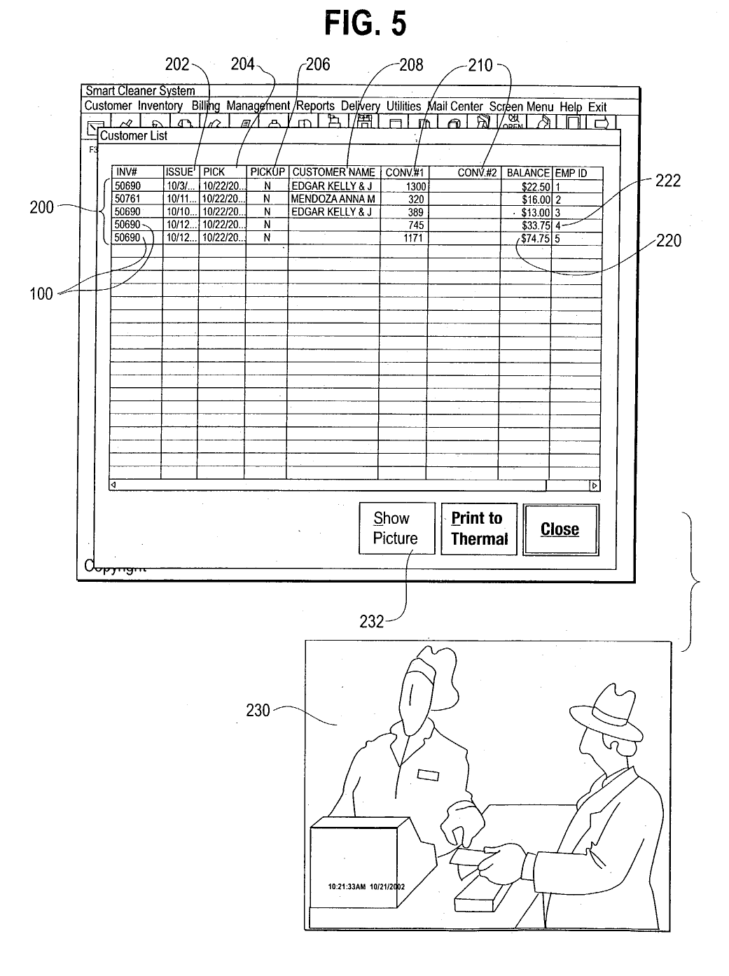

In the present invention, the computer system 11 tracks all cancelled or deleted transactions and compiles a report listing all such cancelled or deleted transactions. Such reports are available only to a supervisor or manager having the appropriate password or key. FIG. 5 shows a screen display of such a report illustrating a list of cancelled or deleted transactions 200. As shown, in this specific embodiment, the report displays the invoice number 100, issue date (drop-off date) 202, pickup date 204, whether the articles have been listed as being picked up 206, customer name 208, conveyer rack numbers 210, customer balance 220, and an identification number 222 of the employee who handled the transaction.

However, when the employee previously cancelled the transaction, the computer system 11 preferably automatically sent a signal to the camera 50 to capture an image 230 of the environment at that time. The image 230 is then stored in the memory subsystem 40 and operatively linked with the transaction number 100. Thus, when the cancelled transaction report is run, the supervisor may instantly recall the captured image 230 associated with the selected transaction number 100. As shown in FIG. 5, the supervisor preferably highlights or clicks on the displayed transaction number 100 and then clicks on the “show picture” icon 232. The captured image 230 is then shown, and may be printed. In the illustrated embodiment, the captured image 230 shows that the customer was present when the employee cancelled the transaction.

However, this could be a legitimate transaction in certain circumstances. The supervisor can confirm this by checking the conveyor rack to see if the existing inventory matches what the report indicates. If the report indicates that the articles are still on the conveyer, but the supervisor confirms that no such articles are found, this indicates that the employee may have cancelled the transaction, given the articles of clothing back to the customer, and pocked the money as if a normal transaction had occurred. The supervisor can then take steps to remedy the problem, as he or she knows which employee may be involved in the fraud, as evidenced by the captured image 230.

Alternatively, the captured image 230 may show only the employee and may not show the customer. This is very suspicious, and may indicate that the employee cancelled a transaction without customer input. This is a very strong indication of fraud. Again, the supervisor can take steps to remedy this situation.

Note that the supervisor can perform the above-described security investigation at any time, and can instantly be apprised of the results. All of the information needed to evaluate the situation is fully integrated and is transparent to the operator or supervisor. All pertinent information may be retrieved based on the transaction identifier 100, such as the invoice number. The supervisor need not retrieve cumbersome videotapes and attempt to synchronize the tape with the transaction, as is required in many prior art surveillance systems, which may be very time consuming.

One basis of the present invention is that it is very difficult to locate an article of clothing and provide it to the customer without knowing where on the conveyer it is located. The only way to know where such articles of clothing are located is by displaying the transaction on the display device to obtain the conveyor rack number 210. When that occurs, the photographic image 230 is automatically captured, thus leaving a trail that leads back to the employee in question. Of course, no anti-fraud system is completely fool-proof, and no systems can completely eliminate all theft and fraud. However, because the employees know that the present inventive system captures the photographic images during the various stages mentioned above, it acts as a strong deterrent and significantly reduces the amount of theft and fraud in the retail establishment.

Note that in the above-described embodiments, the display device may display the captured images in any format along with the transaction data, or may display the image separate and apart from the transaction data. Preferably, the captured image is displayed in a side-by-side format with the transaction shown on one portion of the display screen and the captured image shown on another portion of the display screen. Alternatively, the captured images may be shown superimposed on the transaction in a tiled manner, or may be shown in a “bleed-though” mode where both images can be seen even though one is overlaid on the other. Any suitable display format may be used.

Additionally, the captured images need not be “still” photographs. Such images may be full motion video images recorded over a period of, for example, several seconds to several minutes. Because the image capture device is digital, the images may be converted to JPG or other suitable format regardless of whether the images are still photographs or full motion video. Of course, full motion video requires much more memory storage on the hard disk or memory subsystem.

Specific embodiments of an integrated POS system according to the present invention have been described for the purpose of illustrating the manner in which the invention may be made and used. It should be understood that implementation of other variations and modifications of the invention and its various aspects will be apparent to those skilled in the art, and that the invention is not limited by the specific embodiments described. It is therefore contemplated to cover by the present invention any and all modifications, variations, or equivalents that fall within the true spirit and scope of the basic underlying principles disclosed and claimed herein.

What is claimed is:

1. A point-of-sale system for use in a retail establishment comprising:
a computer system configured to track inventory and associate the inventory with a transaction in accordance with a transaction identifier, the computer system including a memory subsystem and a display device;
a database operatively coupled to the computer system;
a cash drawer operatively coupled to and controlled by the computer system;
an image capture device operatively coupled to the computer system and configured to transmit a selected captured image to the computer system for storage;
the computer system configured to store the captured image in the memory subsystem and operatively link the captured image with the transaction identifier upon receipt of a first predetermined signal; and
the computer system configured to display the transaction on the display device, and upon receipt of a second predetermined signal, display the captured image corresponding to the transaction on the display device.

2. The system according to claim 1 wherein the image capture device is selected from the group consisting of a Web camera, USB camera, video camera, CCD camera, and digital camera.

3. The system according to claim 1 wherein the computer system includes a computer selected from the group consisting of computer, microprocessor, RISC processor, mainframe computer, work station, single-chip computer, distributed processor, server, controller, micro-controller, discrete logic computer, remote computer, internet computer, and web computer.

4. The system according to claim 1 wherein the computer system stores the transaction in the database, the transaction being retrievable or indexed via the transaction identifier.

5. The system according to claim 1 wherein the computer system automatically stores a captured image in the memory subsystem when inventory entering the retail establishment is assigned the transaction identifier.

6. The system according to claim 1 wherein the computer system automatically stores a captured image in the memory subsystem when inventory having an transaction identifier is removed from the retail establishment.

7. The system according to claim 1 wherein the computer system automatically stores a captured image in the memory subsystem when a transaction is cancelled.

8. The system according to claim 1 wherein the computer system stores a captured image in the memory subsystem upon receipt of a user-generated signal.

9. The system according to claim 1 wherein the computer system recalls and displays on the display device a captured image indexed by the transaction identifier.

10. The system according to claim 1 wherein the computer system recalls and displays on the display device the transaction and the captured image corresponding to the transaction identifier.

11. The system according to claim 1 wherein the inventory received by the retail establishment includes items provided by a customer for repair or modification.

12. The system according to claim 1 wherein the retail establishment is selected from the group consisting of a laundry, cleaners, dry cleaners, shoe repair establishment, equipment repair establishment.

13. The system according to claim 1 wherein the computer system provides a list of transaction identifiers representing cancelled transactions, and wherein upon receipt of an image recall signal, the computer system provides the captured image associated with a selected cancelled transaction.

14. The system according to claim 1 wherein the transaction is displayed on the display device and upon receipt of the second predetermined signal, the captured image being display in a side-by-side manner, or in a superimposed manner, or in a bleed-through manner along with the displayed transaction.

15. A point-of-sale system for use in a clothing cleaning or clothing repair establishment adapted to receive items of clothing for cleaning or repair from a customer, the system comprising:
a computer system configured track the items of clothing and associate the items of clothing with a transaction in accordance with a transaction identifier, the computer system including a memory subsystem and a display device;
a database operatively coupled to the computer system;
a cash drawer operatively coupled to and controlled by the computer system;
an image capture device operatively coupled to the computer system and configured to transmit a selected captured image to the computer system for storage;
the computer system configured to store the captured image in the memory subsystem and operatively link the captured image with the transaction identifier upon receipt of a first predetermined signal; and
the computer system configured to display the transaction on the display device, and upon receipt of a second predetermined signal, display the captured image corresponding to the transaction on the display device.

16. A method of tracking articles provided by a customer to a retail establishment and returned back to the customer, and for reducing theft by an employee, the retail establishment having a computer system with a memory subsystem, a display device, a database, and a cash drawer, the method comprising:
operatively coupling an image capture device to the computer system;
creating a transaction and assigning thereto a transaction identifier when the customer provides the articles to the retail establishment for servicing;
storing the transaction in the database;
capturing an image of at least one of the employee and customer when the customer provides the articles to the retail establishment for servicing, when the articles are returned back to the customer, and/or when the employee cancels a transaction;
storing the captured image and operatively linking the captured image to the transaction via the transaction identifier; and
upon receipt of predetermined signal, displaying on the display device a transaction specified by a selected transaction identifier along with the linked captured images to determine the parties present at the time of the transaction.

17. A computer readable memory or data storage means encoded with data representing a computer program for a point-of-sale computer system for use in tracking articles provided by a customer to a retail establishment and returned back to the customer, and for reducing theft by an employee, the computer system including a memory subsystem, a display device, a database, a cash drawer, and image capture device, the computer readable memory or data storage system comprising:
means for operatively coupling the image capture device to the computer system;
means for creating a transaction and assigning thereto a transaction identifier when the customer provides the articles to the retail establishment for servicing;
means for storing the transaction in the database;
means for capturing an image of at least one of the employee and customer when the customer provides the articles to the retail establishment for servicing, when the articles are returned back to the customer, or when the employee cancels a transaction;
means for storing the captured image and operatively linking the captured image to the transaction via the transaction identifier; and
means for receiving a predetermined signal, and in response thereto, displaying on the display device a transaction specified by a selected transaction identifier along with the linked captured images to determine the parties present at the time of the transaction.
